(19) United States
(12) Patent Application Publication
(10) Pub. No.: US 2025/0297694 A1
(43) Pub. Date: Sep. 25, 2025

(54) CONTROLLING HEAT TRANSFER ON CONTROL VALVES

(71) Applicant: Dresser, LLC, Houston, TX (US)

(72) Inventor: Jeremy Asher Glaun, Sharon, MA (US)

(21) Appl. No.: 18/615,434

(22) Filed: Mar. 25, 2024

(51) Int. Cl. F16K 49/00; F16K 3/30

(52) U.S. Cl. CPC F16K 49/00; F16K 3/30

(57) ABSTRACT

A bonnet that is configured for use on a valve. These configurations may comprise a valve stem portion that can receive packing material that surrounds a valve stem. The valve stem portion may be arranged with features that affect how thermal energy dissipates through the structure. In one implementation, these features may embody grooves that reside in proximity to the valve stem. The grooves may extend axially, for example, on an inner surface of a through-bore that extends through the bonnet. The grooves may also form spiral depressions that “wind” around the valve stem. In use, the grooves are useful to increase surfaces area of the through-bore, which in turn changes properties of the bonnet to transfer or exchange heat with the environment around the valve.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Control valves are a type of flow control that operators favor to regulate flow of material (or “process fluid”) on their process lines. These devices may have a valve body that houses valve “trim,” typically a closure member and a seat. A bonnet (or cover) secures to the valve body. The bonnet may have a through-bore to receive a valve stem that connects the closure member to an actuator. Packing material may reside in the through-bore and surround the valve stem to prevent any leak of process fluid that might escape the valve body into the through-bore.

### SUMMARY

The subject matter of this disclosure relates to improvements in flow controls to change heat transfer characteristics of the design. Of particular interest are embodiments that can dissipate thermal energy more efficiently with the ambient environment around the flow control. These embodiments may include features or elements in the bonnet, for example, that can increase heat transfer enough to maintain dimensions of the bonnet, even under “severe” service conditions. These features address concerns that operators have with the packing material as the flow control operates under these “severe” conditions. For example, in systems that flow process fluid at temperatures below 0° C., operators worry that any “subzero” process fluid that might escape the packing material will freeze in the through-bore and form ice that can bind the valve stem. Operators are also wary of systems where process fluid at high temperatures flow, on the other hand, because the flow controls may see temperatures that exceed manufacturer specifications for the packing material. These conditions may cause the packing material to fail and, in some cases, leak process fluid to the atmosphere.

### DRAWINGS

This specification refers to the following drawings:

FIG. 1 depicts a schematic diagram of an embodiment of a bonnet in position on a flow control;

FIG. 2 depicts a schematic diagram of the cross-section from the side of an example of the bonnet of FIG. 1;

FIG. 3 depicts an elevation view of the cross-section from the side of an example of the bonnet of FIG. 1;

FIG. 4 depicts a plan view of the cross-section from the top of the exemplary bonnet of FIG. 3;

FIG. 5 depicts an elevation view of the cross-section from the side of an example of the bonnet of FIG. 1; and

FIG. 6 depicts an elevation view of the cross-section from the side of an example of the bonnet of FIG. 1.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, does not exclude plural of any such designation, unless the specification explicitly recites or explains such exclusion. Further, any references to “one embodiment” or “one implementation” does not exclude the existence of additional embodiments or implementations that also incorporate the recited features.

### DESCRIPTION

The discussion now turns to describe features of the examples shown in the drawings noted above. It is not uncommon for flow controls, like control valves, to adopt specific or purpose-driven designs to satisfy operator requirements for their process lines. These designs may deviate from dimensions, construction, or other factors that can increase cost or complexity, as well as introduce other potential problems into the device. On the other hand, the proposed designs avoid the need to deviate from “conventionally sized” designs to accommodate process fluids at extremely high or low temperatures. Other embodiments are within the scope of this disclosure.

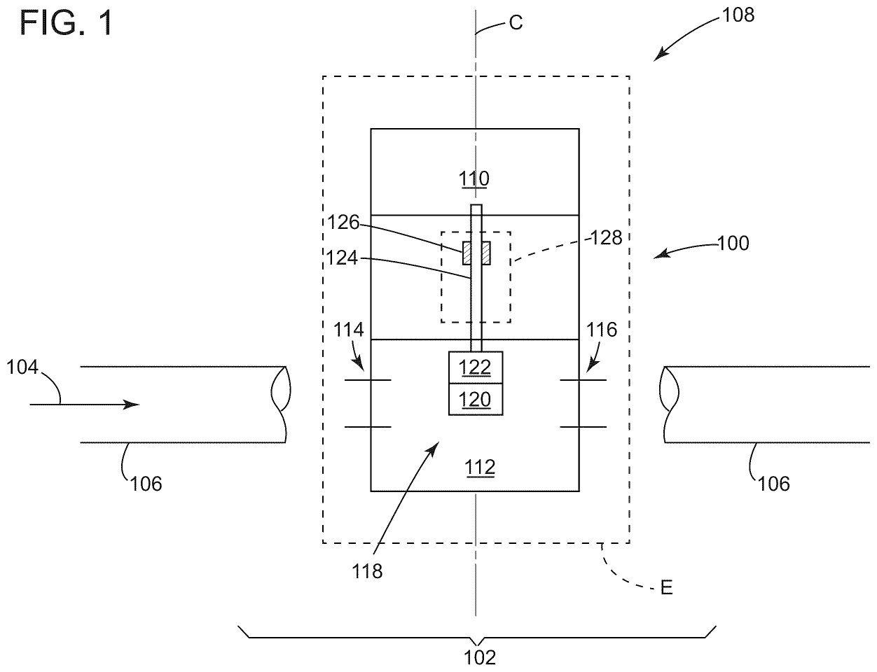

FIG. 1 depicts a schematic diagram of an exemplary embodiment of a bonnet 100. This embodiment is part of a distribution network 102, typically designed to carry material 104 through conduit 106. In one implementation, the bonnet 100 is part of a flow control 108 that may integrate into the network 102. The flow control 108 may comprise an actuator 110 that resides on one side of the bonnet 100. A valve body 112 may reside on the other side of the bonnet 100. The valve body 112 may have openings, identified here as an inlet 114 and an outlet 116. Valve mechanics 118 may reside in the valve body 112 to regulate flow of material 104 from the inlet 114 to the outlet 116. The valve mechanics 118 may include a seat 120 and a closure member 122. A valve stem 124 may couple the closure member 122 with the actuator 110. Packing material 126 may circumscribe the valve stem 124 and reside in a valve stem portion 128 of the bonnet 100.

Broadly, the bonnet 100 may be configured to improve heat transfer. These configurations may adopt or incorporate elements or features that can increase surface area in particular areas of the device. The larger surface area that results from these features may, in turn, increase thermal transfer properties of the bonnet 100 that can better dissipate heat (and cold) into and out of the bonnet 100 with the ambient environment in proximity to the device. These properties may result in designs for the bonnet 100 that fit within a working envelope E that is much smaller than that of designs that currently require extended or enlarged pieces to dissipate heat (and cold) at the same rates. This feature is beneficial because operators can adopt the bonnet 100 without compromise to layout restrictions in their facilitates or performance of the device. The more “conventionally sized” bonnet design proposed herein also avoids additional expenses and complexity to manufacture and are, better yet, much less prone to low natural frequencies than longer, thin-walled units.

The distribution system 102 may be configured to deliver or move these fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material in these networks. These configurations may find use on process lines that flow process fluids at a variety of process temperatures, including both sub-zero temperatures and high temperatures (e.g., greater than 500° C.). This disclosure does contemplate, however, that the concepts herein may apply to similar situated devices and systems that handle liquids across a range of temperatures, pressures, or other operating conditions. Preferably, the actuator 110 operates in response to a pneumatic signal; however, this disclosure does contemplate use of electronic devices as well. The valve body 112 may comprise cast or machined metals. This structure may form a flange at the openings 114, 116. Adjacent pipes 106 may connect to the flanges to allow material 104 to flow through the device. Preferably, the valve mechanics 118 may change the operating condition of the flow control 108 as defined, for example, by where the closure member 122 locates relative to the seat 120. This distance may allow appropriate flow of material 104 through the device to satisfy process requirements on the process line. Suitable construction of components 120, 122 may allow the valve 108 to operate under extreme temperatures or pressure, as well with materials 104 that are caustic or hazardous. The valve stem 124 may embody an elongated, cylindrical member that can transfer a load from the actuator 110 to the closure member 122. Packing material 126 may contact both the valve stem 124 and the bonnet 100 to create a seal that prevents escape of material 104 that can transit into the bonnet 100.

The valve stem portion 128 may be configured to change heat transfer with the area surrounding the flow control 108. These configurations may find use to dissipate heat (and cold) away from the packing material 126 or areas in proximity (e.g., above or below) the packing material 126. These improvements can allow manufacturers to maintain the length of the bonnet 100 at or near dimensions that operator's prefer, even on process lines that operate under severe process conditions. As noted herein, arrangements of the valve stem portion 128 may better dissipate heat that transfers through the bonnet 100 (to the packing material 126) from hot fluid (e.g., >500° C.) that flows through the valve body 112. These arrangements may also better transfer heat to “warm” cold fluid (e.g., <0° C.) that may transit the bonnet 100 from the valve body 112.

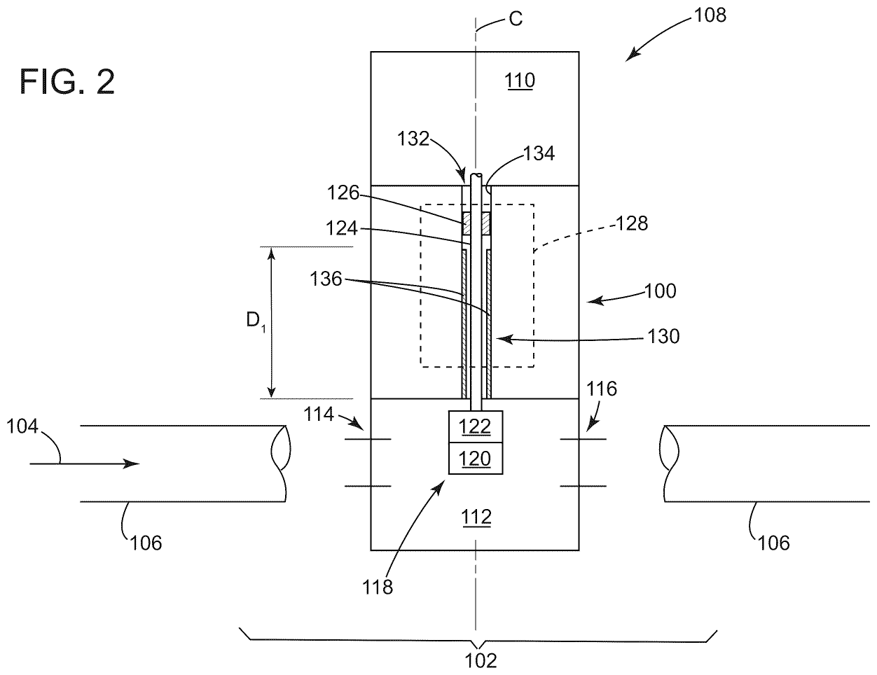

FIG. 2 depicts another schematic diagram of an elevation view of the cross-section from the side of exemplary structure for the bonnet 100 of FIG. 1. The valve stem portion 128 may include thermal dissipating structure 130 that facilitates thermal transfer. The thermal dissipating structure 130 may include a bore 132 that receives the valve stem 124 and the packing material 126. The bore 132 may have an inner surface 134. Integral thermal features 136 may populate the inner surface 134. The integral thermal features 136 may increase the surface area of the inner surface 134, which increases the thermal transfer area available to dissipate thermal energy through the bonnet 100. This thermal transfer area may, in turn, foreclose the need to increase the packing material distance Di to avoid damage or breakdown of the packing material 126 as noted herein. As a result, the bonnet 100 may adopt dimensions that fit within the customary envelope E for the flow control 108.

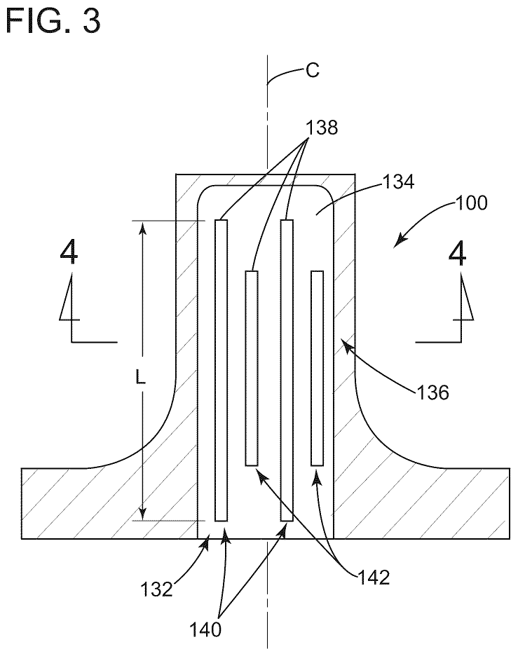

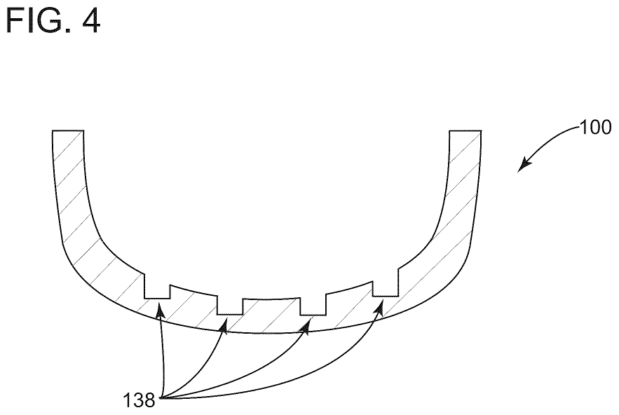

FIGS. 3 and 4 depict exemplary structure for the bonnet 100 of FIGS. 1 and 2. FIG. 3 depicts an elevation view of the cross-section from the side. The thermal features 136 may include grooves 138 that populate the inner surface 134. In one implementation, the grooves 138 may extend axially in the bore 132 along axis C. The grooves 138 may also sit radially apart from one another around the axis C, preferably so that the grooves 138 circumscribe the axis C. In one implementation, the grooves 138 may have a length L that extends from the bottom of the bonnet 100 to the top of the bonnet 100. However, this disclosure contemplates that the length L may vary as well. For example, the grooves 138 may assume a pattern that includes a first set of grooves 140 that is longer than a second set of grooves 142. As best shown in the cross-section of FIG. 4, the grooves 138 may adopt geometry with a cross-section that is square or rectangular in shape. Other geometry may prevail in which the shape is circular or rounded, as desired.

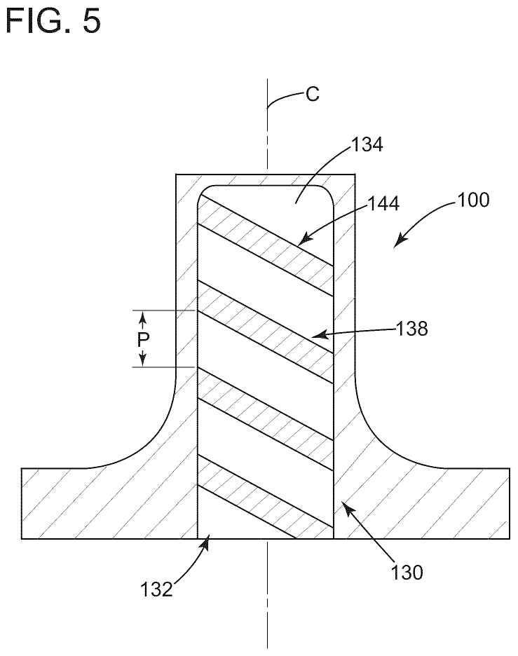

FIG. 5 depicts an elevation view of the cross-section from the side of other exemplary structure for the bonnet 100 of FIGS. 1 and 2. The pattern for the grooves 138 may form spiral depressions 144 that circumscribe the axis C. The spiral depressions 144 may be spaced apart from one another a pitch P. In one implementation, the pitch P may assume a pitch value that remains constant, for example, in a direction from the bottom of the bonnet 100 to the top of the bonnet 100. The pitch value may also vary in this direction so that adjacent spiral depressions 144 may be closer to one another than others. For example, the design may set the pitch value smaller for the spiral depressions 144 at the bottom of the bonnet 100 than at the top of the bonnet 100, or vice versa.

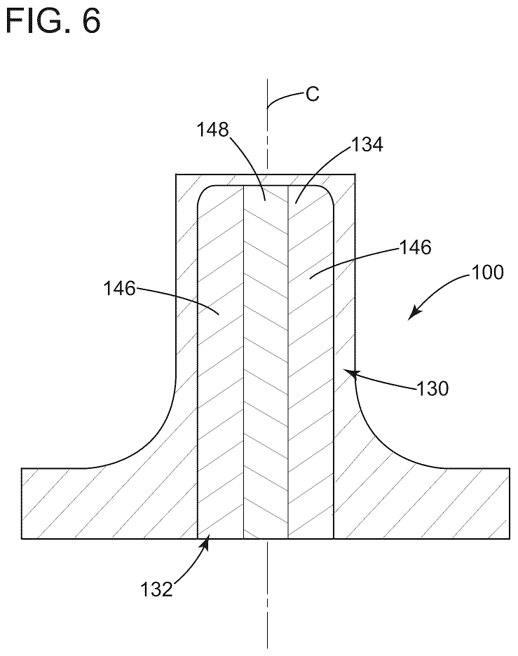

FIG. 6 depicts an elevation view of the cross-section of still other exemplary structure for the bonnet 100 of FIGS. 1 and 2. This structure incorporates thermal areas 146, 148 into the inner surface 134 of the bore 132. The thermal areas 146, 148 may correspond with construction of the bonnet 100 that uses materials with different properties, for example different heat transfer coefficients. In one implementation, thermal areas 146, 148 may identify areas of alternating high heat transfer and low heat transfer. This design may create thermal flows that create zones of forced convection to change thermal transfer through the bonnet 100.

Considering the foregoing, the improvements herein maintain the bonnet 100 within manufacturers' (and, often times, operators') preferred operating envelope. This feature can benefit operators because it avoids “longer” or like designs for the bonnet 100, which in turn reduces cost to manufacture the device. This “shorter” design is also more robust because it is not prone to vibrate at lower natural frequencies as compared to the longer designs.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A valve, comprising:
a valve body;
a bonnet coupled to the valve body, the bonnet comprising a valve stem portion;
packing material disposed in the valve stem portion; and
a valve stem extending through the packing material and the valve stem portion,
wherein the valve stem portion comprises a thermal dissipating structure that is configured to facilitate thermal transfer through the bonnet.

2. The valve of claim 1, wherein the thermal dissipating structure comprises grooves disposed in proximity to the valve stem.

3. The valve of claim 1, wherein the thermal dissipating structure comprises grooves disposed in proximity to the valve stem and extending axially along the valve stem.

4. The valve of claim 1, wherein the thermal dissipating structure comprises grooves disposed in proximity to the valve stem and spaced radially apart from one another around the valve stem.

5. The valve of claim 1, wherein the thermal dissipating structure comprises grooves of different groove length disposed in proximity to the valve stem.

6. The valve of claim 1, wherein the thermal dissipating structure comprises grooves of different groove length disposed in proximity to the valve stem and spaced radially apart from one another around the valve stem.

7. The valve of claim 1, wherein the thermal dissipating structure comprises spiral depressions disposed in proximity to the valve stem.

8. The valve of claim 1, wherein the thermal dissipating structure comprises spiral depressions disposed in proximity to the valve stem and having a pitch that is constant.

9. The valve of claim 1, wherein the thermal dissipating structure comprises spiral depressions disposed in proximity to the valve stem and having a pitch that varies.

10. The valve of claim 1, wherein the thermal dissipating structure comprises thermal areas in proximity to the valve stem that comprise materials that have different material properties.

11. The valve of claim 1, wherein the thermal dissipating structure comprises thermal areas in proximity to the valve stem that comprise materials that have different heat transfer coefficients.

12. A valve, comprising:
a valve body;
a closure member disposed in the valve body;
a valve stem coupled to the closure member; and
a bonnet coupled to the valve body, the bonnet comprising a through bore having an inner surface, the inner surface comprising grooves.

13. The valve of claim 12, wherein the grooves extend axially in the through bore.

14. The valve of claim 12, wherein the grooves are arranged in a spiral in the through bore.

15. The valve of claim 12, wherein the grooves have a square cross-section.

16. The valve of claim 12, wherein the grooves comprise a first set of grooves having a first dimension and a second set of grooves having a second dimension that is different from the first dimension.

17. The valve of claim 12, wherein the grooves comprise a first set of grooves having a first length and a second set of grooves having a second length that is different from the first length.

18. A valve, comprising:
a valve body;
a bonnet disposed on the valve body;
packing material disposed in the bonnet;
a valve stem extending through the packing material, the valve stem having a longitudinal axis; and
grooves disposed in proximity to the valve stem.

19. The valve of claim 18, wherein the grooves extend along the longitudinal axis.

20. The valve of claim 18, wherein the grooves are disposed at an angle to the longitudinal axis.
